(19) United States
(12) Patent Application Publication
(10) Pub. No.: US 2005/0226492 A1
(43) Pub. Date: Oct. 13, 2005

(54) Acceptable defect positioning and manufacturing method for large-scaled photomask blanks

(75) Inventor: Ming-Feng Ho, Hsinchu City (TW)

Correspondence Address: TROXELL LAW OFFICE PLLC, SUITE 1404, 5205 LEESBURG PIKE, FALLS CHURCH, VA, 22041, US

(73) Assignee: Allied Integrated Patterning Corporation

(21) Appl. No.: 10/940,610

(22) Filed: Sep. 15, 2004

(30) Foreign Application Priority Data
Apr. 9, 2004 (TW) 093109840

(51) Int. Cl. G06K 9/00

(52) U.S. Cl. 382/144

(57) ABSTRACT

Disclosed is an acceptable defect positioning and manufacturing method for large-scaled photomask blanks, where the defective information of the entire large-scaled photomask blanks or etched and to-be-repaired photomask, upon being acquired by a photomask inspection apparatus, is categorized into a critical area a non-critical area. The so-called critical area is directed to areas where defects are unacceptable, while the non-critical area is directed to areas where defects are acceptable. For large-scaled photomask blanks, if all defects are within the non-critical area, the photomask blanks are deemed acceptable. For large-scaled photomasks, photomask acceptance system only needs to reject photomask blanks whose defects are within the critical area of the mask products.

### CROSS-REFERENCES TO RELATED APPLICATIONS

Not Applicable

### STATEMENT REGARDING FEDERALLY SPONSORED RESEARCH OR DEVELOPMENT

Not Applicable

### DESCRIPTION

1. Field of Invention

This invention relates to an acceptable defect positioning and manufacturing method for large-scaled photomask blanks, particularly to one where the defective information of the entire large-scaled photomask blanks or etched and to-be-repaired photomask, upon being acquired by a photomask inspection apparatus, is categorized into a critical area a non-critical area. The so-called critical area is directed to areas where defects are unacceptable, while the non-critical area is directed to areas where defects are acceptable. For large-scaled photomask blanks, if all defects are within in the non-critical area, the photomask blanks are deemed acceptable. For large-scaled photomasks, photomask acceptance system only needs to reject those photomask blanks having defects within the critical area.

2. Background

LCD provides the advantages of compactness, lightweight, low driving voltage, low power consumption, portability and low space occupation. LCD products are widely implemented in a variety of applications, from articles for daily uses to high-level industrial uses, such as timepieces, calculators, TV, communications, medical equipment, transport aviation, industrial equipment, and military applications. At the present, high quality LCD has gradually replaced the conventional CRT.

The process for fabricating LCD is generally described as follows: cleaning a glass substrate (pre-cleaning); forming an indium tin oxide (ITO) conductive layer over the glass substrates (patterning); forming a polyemid layer over the ITO conductive layer (polyemid rubbing); distributing a spacer between two glass substrates and printing an insulated substance, such as epoxy resin, at peripheries of the two glass substrates (spacer and seal depositing); combining two glass substrates (cell assembling); cutting and trimming; Liquid crystal fluid filling, pressing and sealing; chamfering corners of glass substrates; inspecting LCD panels; attaching polarizer; and final inspection.

The LCD color filters are applied to one of the glass substrates by adopting different process to coat a black matrix and an RGB color filter film. A patterned conductive layer, such as an ITO conductive layer, is then deposited thereover to serve as common electrode for driving the liquid crystal upon combining the glass substrate to the thin film transistor array (TFT array) coated over another glass substrate (the patterning step), so as to obtain a color LCD serving as a color filter required for displaying colors.

In the above process for fabricating LCD as described above, the steps of patterning, polyemid rubbing, or formation of the black matrix and RGB color filter film all require the use of lithography. For example, in order to deposit a conductive layer over the glass substrate, a photomask having a required conductive layer pattern is first provided. A photoresist layer then coated over the glass substrate. When parallel light originating from a light source is projected on the photoresist layer through the photomask, a pattern identical to the conductive layer pattern of the photomask will then been formed in the photoresist layer. In other words, the pattern of the photomask is then completely transferred to the photoresist layer. The photomask is then subject to developing and etching so as to form a conductive layer with the required pattern over the glass substrate.

Hence, to improve the LCD yield, the precision involve in the production of photomask patterns is particularly essential. The main body of the photomask is constructed of a flat, insulated and transparent quartz glass. The photomask may also be constructed of a material other than quartz glass. Other materials that are commonly adopted include soda glass, soda lime, emulsion photomask and quartz glass, among which quartz glass is the most frequently employed.

Then, a layer of opaque film or light absorbing material is then coated over the quartz glass. It should be noted that, the pattern required for the conductive layer is formed within the layer of opaque film (such as a metal layer) or light absorbing material. Generally speaking, chromium, nickel or aluminum may be adopted to serve as the metal layer. A photoresist is then coated over the opaque film. High-resolution exposure technology by using laser beam or electronic beam generated by an exposure machine would then expose the pattern to the photoresist. An engineer would then apply developer to the photoresist to develop the pattern in the opaque film. The pattern would then be transferred to the opaque film by etching to form a transparent area and an opaque area over the photomask.

However, in the process of preparing the photomask, it is relatively difficult to make defect-free photomasks. Thus, repair needs to be applied to the photomasks prior to duplicating the pattern by means of lithography. The defects found in a photomask are generally categorized into transparent defects (pinhole defects) and opaque defects, wherein the transparent defects are those within the opaque area that should have been formed with the opaque film but is not, while the opaque defects are those within the transparent area that should have not been formed with the opaque film but is. Thus, the repair for the photomask includes filling pinhole defects and removing opaque defects.

With reference to FIG. 1A that illustrates a top plan view of a photomask having defects, the photomask 100 includes opaque areas 102, 104 and a transparent area 110. Within the opaque area 104 is formed with a pinhole defect 106, and within the transparent area 110 is formed with an opaque defect 108. FIG. 1B illustrates a cross-sectional view of a photomask taken along lines I-I of FIG. 1A. The pinhole defect 106 and opaque defect 108 may be easily observed in FIG. 1B.

FIG. 2 illustrates the repair applied to the photomask 100, in which the opaque defect 108 within an opaque defect removing area 114 has been removed and a pinhole repair area 112 is formed within the opaque area 104 to repair the pinhole defect 106. FIG. 2B illustrates a cross-sectional view of a photomask taken along lines II-II of FIG. 2A. One can observe from 2B that the pinhole repair area 112 covers part of the opaque area 104 and the entire pinhole defect 106, while the opaque defect 108 has been removed to repair the defects on the photomask 100.

The conventional techniques adopted in repairing photomasks include laser beam, focused ion beam, and atomic force microscopy. Due to the limited resolution of laser beam, laser ablation may possibly remove the opaque film neighboring the defect area thereby damaging the photomask pattern. In addition, due to the significant heat transmitted by the laser beam, not only can the heat dissolve and evaporate the opaque defect, but also cause damages and roughen the quartz neighboring or located beneath the opaque defect, thereby reducing the light transmission of the quartz and altering the phase of the transmissive light. Because the focused ion beam is advantageous in having a focus dimension that is far smaller than that of the laser beam, it has been widely implemented in the repair for photomask in view of its repair precision and high yield.

However, there are several shortcomings that need to be resolved in implementing the focused ion beam to repair the photomasks. First, because the photomask is formed over blanks, such as quartz, while quartz is an insulated material, the ion beam would charge the blanks and thus reduce the capability of image forming by using ion beam. In addition, because (Ga+) can be focused into an ion beam having an extremely low radius, gallium ion beam is commonly adopted by the focused ion beam for cases that require high resolution. Upon impacting the defect area on the photomask by the gallium ion beam, the area neighboring the impacted area would be charged with secondary ions or electrons thereby implanting the Ga+ into the quartz blanks, exhibiting a charging state that is gradually developed at the impacted area. The low intensity of the secondary ions or electrons would impair the imaging quality or even attenuate the overall signals, thereby forming isolated patterns or preventing formation of pin dots. On the other hand, the charging state of the impacted area will also cause diffusion or even direction changing of the Ga+, thereby reducing the precision in repairing the pattern defects.

Furthermore, the size required in preparing the photomasks increases along with the consumer's demands for large-scaled LCD, and the promotion of LCD TV and digital broadcasting. The number of the defects found in a large-scaled photomask blank or etched and to-be-repaired large-scaled photomask increase as well. Thus, other than the problem of a low passing rate of large-scaled photomask blanks, the cost and time required for repairing large-scaled photomask defects has also increased.

### SUMMARY OF INVENTION

In view of the problem of increasing number of the defects found in the conventional large-scaled photomask blank or etched and to-be-repaired large-scaled photomask, which results in a low passing rate, and increasing cost and time required for repairing large-scaled photomask defects, this invention provides an acceptable defect positioning and manufacturing method for large-scaled photomask blanks that would eliminate such problem.

It is thus a primary objective of this invention to provide an acceptable defect positioning method for large-scaled photomask blanks that would improve the passing rate of large-scaled photomask blanks.

It is another objective of this invention to provide a method for manufacturing large-scaled photomasks that would reduce the frequency for repairing the large-scaled photomasks.

To achieve the above objectives, this invention discloses an acceptable defect positioning method for large-scaled photomask blanks, comprising the steps of: placing a photomask blank over a photomask inspection system; capturing an image of the photomask blank by the photomask inspection system; comparing the image of the photomask blank by the photomask inspection system; outputting positions of the defects on the photomask blank by the photomask inspection system; and determining the positions of the defects on photomask blank, wherein the photomask blank is deemed acceptable when all of the defects are within a non-critical area.

Based on the above method, the step of determining the positions of the defects on the photomask is performed by the photomask inspection system.

Based on the above method, parts of the frames for capturing the image of the photomask by the photomask inspection system overlap each other.

Based on the above method, the non-critical area refers to area that does not reduce the passing rate of the overall fabrication process.

This invention further provides a method for manufacturing large-scaled photomask, comprising the steps of: introducing an etched and to-be-repaired photomask to a photomask inspection system; capturing an image of the photomask by the photomask inspection system; comparing the image of the photomask by the photomask inspection system; outputting positions of the defects on the photomask by the photomask inspection system; determining the positions of the defects on the photomask that are within the critical area; and repairing the defects on the photomask that are within the critical area by a photomask repair system.

Based on the above method, the step of determining the positions of the defects on the photomask is performed by the photomask inspection system. When defects are in the critical area of one product, the acceptance test will be performed on the same photomask blank to see if all the defects are in the non-critical area of another mask product. As such, the tested photomask blank is deemed acceptable for those mask products if all the defects are in the non-critical area.

Based on the above method, parts of the frames for capturing the image of the photomask by the photomask inspection system overlap each other.

Based on the above method, the critical area refers to area that will reduce the passing rate of the overall fabrication process.

### BRIEF DESCRIPTION OF THE DRAWINGS

These and other modifications and advantages will become even more apparent from the following detailed description of a preferred embodiment of the invention and from the drawings in which:

FIG. 1A is a top plan view of a photomask having defects;

FIG. 1B is a cross-sectional view of a photomask taken along lines I-I of FIG. 1A;

FIG. 2A is a top plan view of a photomask having defects, where repairs have been applied to the defects;

FIG. 2B is a cross-sectional view of a photomask taken along lines II-II of FIG. 2A;

FIG. 3 is a block diagram of a photomask inspection apparatus;

FIG. 4 is a schematic drawing of the image capturing area of the photomask inspection apparatus;

FIG. 5 is a flow chart illustrating the process of positioning acceptable defect of a large-scaled photomask blank according to this invention; and

FIG. 6 is a method for manufacturing a large-scaled photomask manufacturing method according to this invention.

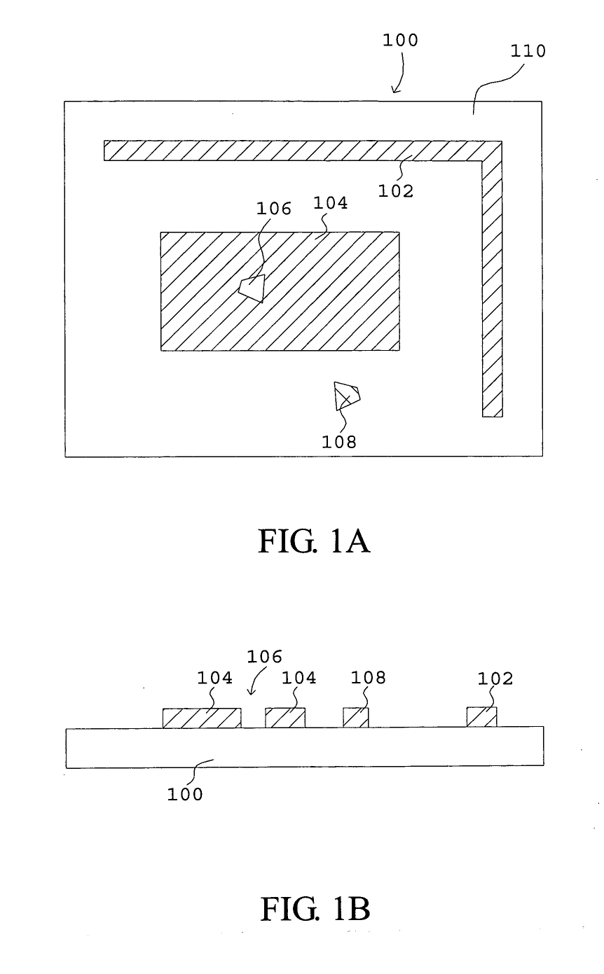

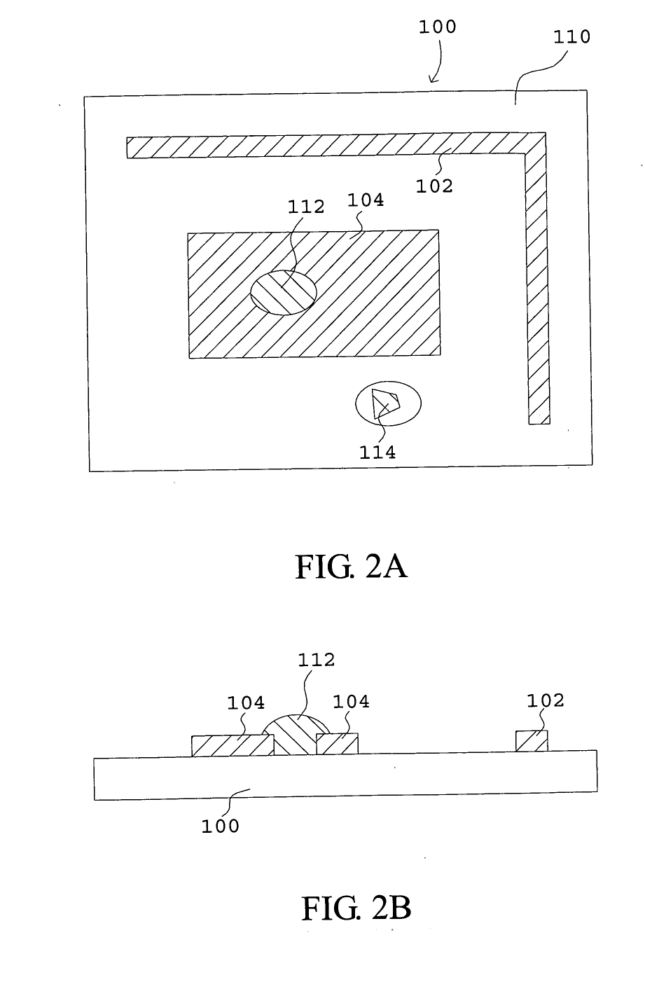

### DETAILED DESCRIPTION OF THE INVENTION (PREFERRED EMBODIMENTS)

An embodiment of this invention is described as follows. Such explanations, however, are not intended to limit the scope of this invention, which is based on the appended claims.

In the method of inspecting photomask defects, the photomask pattern is compared with the computer-aided design (CAD) system for drafting the photomask pattern. Photomask inspection apparatus includes: an XY table for supporting photomask; an image capturing optical system for capturing the pattern image of the photomask supported by the XY table; an image input unit for acquiring an captured image from the image capturing optical system; a data converter for converting CAD data representing the photomask pattern into a reference image; an image comparator for comparing the captured image and the reference image so as to inspect pattern defects; and a controller controlling the apparatus.

In the photomask inspection apparatus, the XY table for supporting the photomask may be displaced, while the image capturing optical system and image input unit capture a frame image of the pattern on the photomask. The image as acquired is then transmitted to the image comparator. On the other hand, the reference image is first converted by the data converter from the CAD data and transmitted to the image comparator at the same time of transmitting the image. The image comparator will inspect whether defects are found in the image with reference to the reference image.

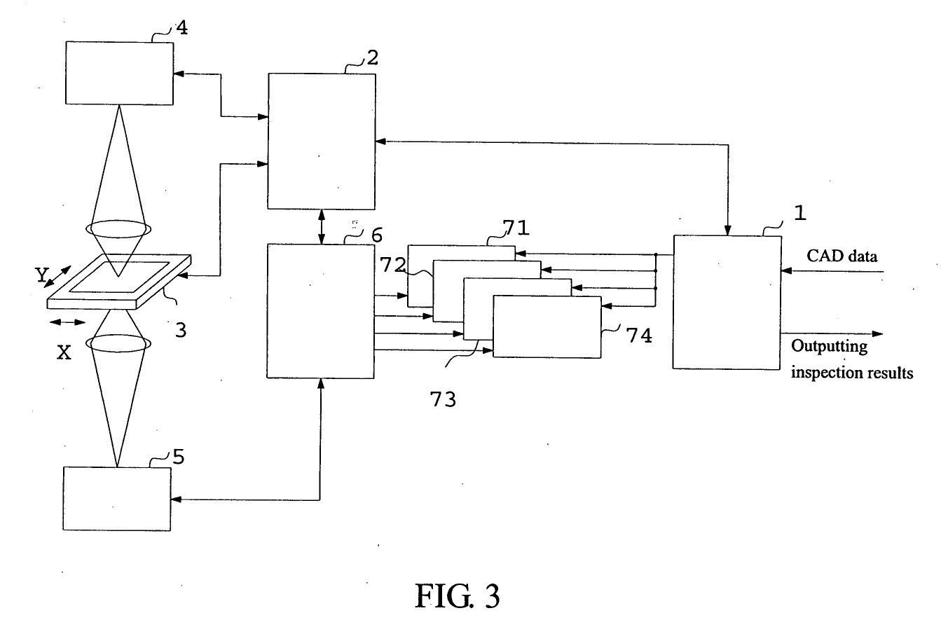

With reference to FIG. 3, the photomask inspection apparatus includes: an XY table 3 for supporting photomask; and an image capturing optical system for capturing the photomask pattern of the pattern supported by the XY table 3. The image capturing optical system includes: a laser-scan optical system 4; and a photodetector 5. An image input splitter 6 splits the captured image pattern into frames, which are then sequentially transmitted to plural image comparators 71-74. Each image comparator 71-74 generates a reference image and detects patterns defects. An inspection controller 1 distributes CAD data for drafting the photomask pattern to the image comparators 71-74. The inspection controller 1 is also featured with the function of generating the inspection results for displaying defective information as inspected by the image comparators 71-74. A main controller 2 controls the XY table 3, laser scan optical system 4 of the image capturing optical system, image input splitter 6, and inspection controller 1.

At the beginning of inspection, the image capturing optical system (laser scan optical system 4 and photodetector 5) and image input splitter 6 will capture frame images one by one, which are then transmitted to the image comparator 71-74 by succeeding channel switching. Each image comparator 71-74 will compare the captured image with the reference image (CAD data) transmitted by the inspection controller 1 to inspect whether there are any defects. When the captured image has been distributed to the last channel, the image input splitter 6 returns to the first channel and initiates another distribution cycle. Each image comparator 71-74 will perform a series of inspection within a cycle period. Extended processing time is made available to each image comparator 71-74 when the number of channels increases.

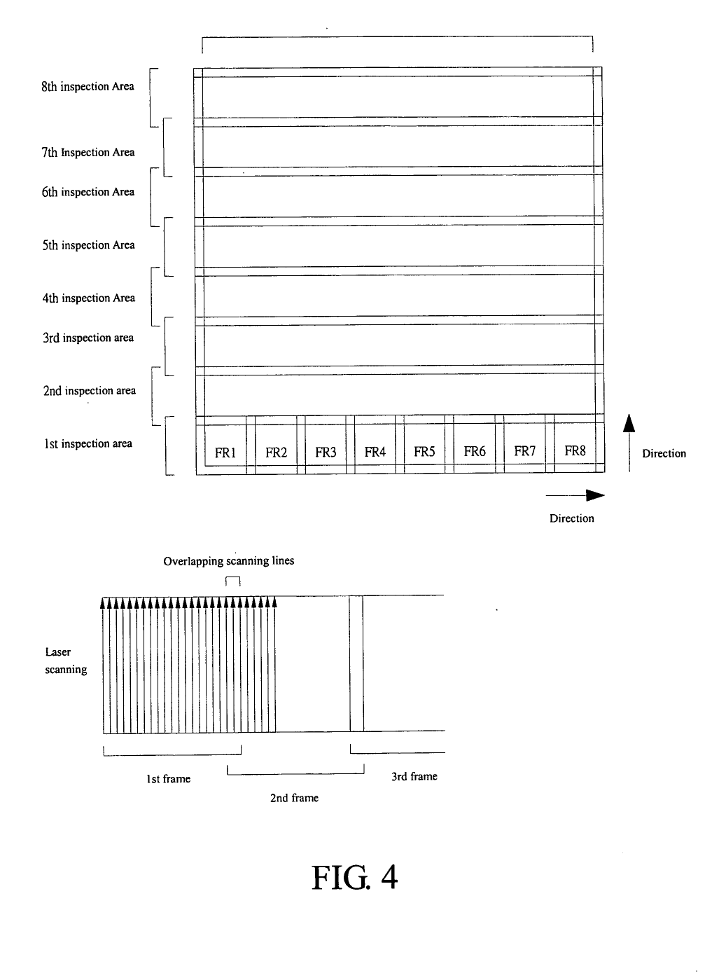

With reference to FIG. 4, the main controller issues a command causing the XY table 3 and the laser scan optical system 4 to start capturing images. The first to the eight frames for the first inspection area of the photomask supported by the XY table 3 are captured by adopting the following process. The XY table 3 moves along the X-direction under a fixed speed. Within each predetermined displacement interval along the X-direction, the laser scan optical system 4 uses a laser beam to scan along the Y-direction. The photodetector would detect an emitted light to acquire a 2-dimensional image. Then, the same procedure is repeated to acquire images of the second inspection area upon moving the XY table 3 along the X-axis for a predetermined interval. The image of the entire photomask surface will then be captured by repeating the above procedures. These captured images are detected by the photodetector 5 and transmitted to the image input splitter 6.

In each of the frame as acquired, a few number of the scanning lines are overlapped with the neighboring frames and recorded into two frames simultaneously, to prevent the failure of locating defects because the neighboring frames are processed by two comparators among the image comparators 71-74, such that defects that are at the boundary of two frames and their neighboring area will be lost.

The operations of the image comparator 71 are described as follows. The image comparators 72-74 are operated by the same procedure at different time. After the inspection has started, the image comparator 71 would acquire the CAD data of the first frame, expand the CAD data into a bit map, and generate a reference image by graduation treatment. The objective of the graduation treatment is to allow the reference image to be compared with the captured image for inspection of defects. The result of the defect inspection is then transmitted to the inspection controller 1. The inspection controller 1 will consider the number of overlapped scanning lines and integrate the results of the defect inspection generated by the image comparators 71-74, and then generate and output the defective information of the entire photomask.

The features of the acceptable defect positioning and manufacturing method for large-scaled photomask blanks of this invention reside in that, upon acquiring the defective information of the entire large-scaled photomask, the defective information is categorized into critical area and non-critical area. The so-called critical area is directed to areas where defects are unacceptable. For example, if a defect on the patterned photomask for a conductive layer happens to be located at the connecting lead pattern of the conductive layer, which would result in open or broken circuits of the connecting lead, such an area is considered one at where defects are unacceptable. The non-critical area is directed to areas where defects are acceptable. For example, if a defect on the patterned photomask for a conductive layer is at location that does not affect the lead pattern of the conductive layer, nor the subsequent manufacturing processes, such an area is considered one at where defects are acceptable. By distinguishing the defective information of the large-scaled photomask in such a manner, only defects that are within the critical area need to be repair. As such, the frequency required for repairing the photomask defects reduces significantly, thereby reducing the manufacturing cost and leadtime. Particularly, the standards for determining whether a photomask defect is within the critical or non-critical area are dependent on whether such defects would affect the overall passing rate of the entire manufacturing process, but not limited to the position of the defect on the photomask.

Such measures may be also adopted in setting the passing standards of large-scaled photomask blanks. For a photomask blank that has been inspected by the photomask inspection apparatus, if all defects are within the non-critical area, the photomask blank is deemed acceptable. On the other hand, if any of the defects is within the critical area, the photomask blank is deemed unacceptable. As such, more flexibility is provided to the large-scaled photomask blank supply.

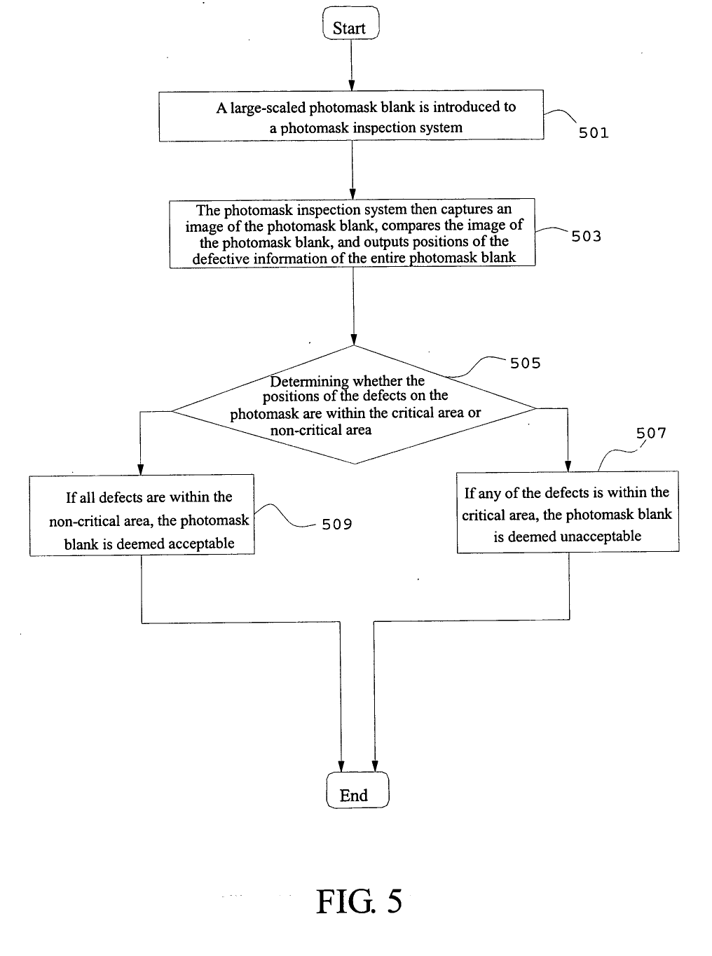

FIG. 5 is a flow chart illustrating the process of positioning acceptable defect of a large-scaled photomask blank according to this invention. A large-scalled photomask blank is first introduced to a photomask inspection system (Step 501). The photomask inspection system then captures an image of the photomask blank, compares the image of the photomask blank, and outputs positions of the defective information of the entire photomask blank (Step 503). The flow then proceeds to determine whether the positions of the defects on the photomask are within the critical area or non-critical area (Step 505). If all defects are within the non-critical area, the photomask blank is deemed acceptable (Step 507). On the other hand, if any of the defects is within the critical area, the photomask blank is deemed unacceptable (Step 509). Step 505 may be modified such that it is accomplished at the same time that the photomask inspection system outputs the defective information of the photomask blank.

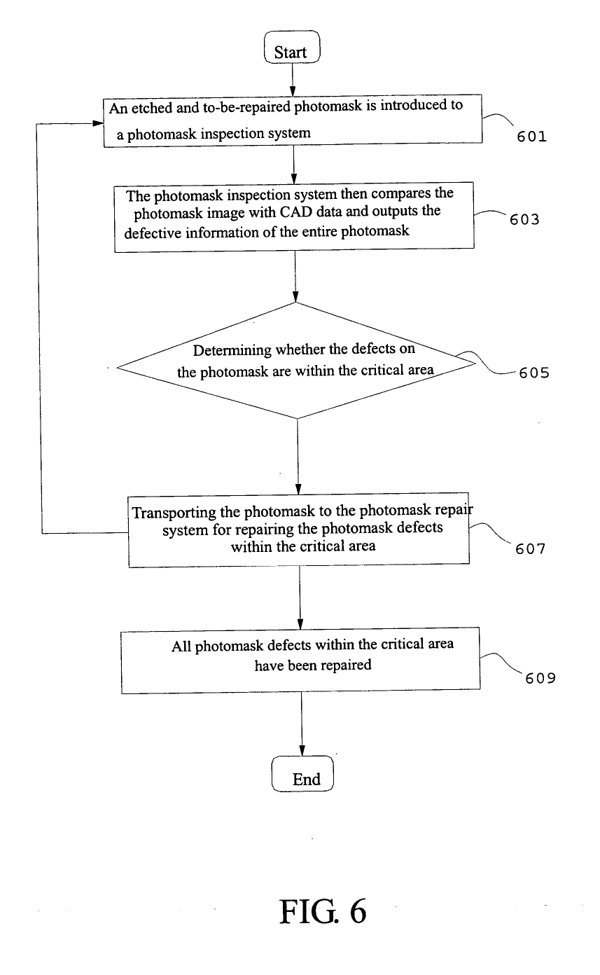

FIG. 6 is a method for manufacturing a large-scaled photomask manufacturing method according to this invention. A large-scaled, etched and to-be-repaired photomask is first introduced to a photomask inspection system (Step 601). The photomask inspection system then compares the photomask image with CAD data and outputs the defective information of the entire photomask (Step 603). The flow then proceeds to determine whether the defects on the photomask are within the critical area or non-critical area (Step 605). The photomask is then transported to the photomask repair system for repairing the photomask defects within the critical area (Step 607). Repeating Steps 601 to until all photomask defects within the critical area have been repaired (Step 609). Step 605 may be modified such that it is accomplished at the same time that the photomask inspection system outputs the defective information of the photomask.

This invention is related to a novel creation that makes a breakthrough in the art. Aforementioned explanations, however, are directed to the description of preferred embodiments according to this invention. Since this invention is not limited to the specific details described in connection with the preferred embodiments, changes and implementations to certain features of the preferred embodiments without altering the overall basic function of the invention are contemplated within the scope of the appended claims.

1. An acceptable defect positioning method for large-scaled photomask blanks, comprising the steps of:
a. introducing a photomask blank to a photomask inspection system;
b. capturing an image of the photomask blank by the photomask inspection system;
c. comparing the image of the photomask blank by the photomask inspection system;
d. outputting positions of the defects on the photomask blank by the photomask inspection system; and
e. determining the positions of the defects on photomask blank, wherein the photomask blank is deemed acceptable when all of the defects are within a non-critical area.

2. The acceptable defect positioning method for large-scaled photomask blanks of claim 1, wherein the step of determining the positions of the defects on the photomask blank is performed by the photomask inspection system.

3. The acceptable defect positioning method for large-scaled photomask blanks of claim 1, further comprising the steps of:
f. repeating steps a through d when the photomask blank is deemed unacceptable; and
g. determining the positions of the defects on photomask blank, wherein the photomask blank is deemed acceptable when all of the defects are within a second non-critical area.

4. The acceptable defect positioning method for large-scaled photomask blanks of claim 1, wherein parts of the frames for capturing the image of the photomask blank by the photomask inspection system overlap each other.

5. The acceptable defect positioning method for large-scaled photomask blanks of claim 2, wherein parts of the frames for capturing the image of the photomask blank by the photomask inspection system overlap each other.

6. The acceptable defect positioning method for large-scaled photomask blanks of claim 1, wherein the non-critical area refers to area that does not reduce the passing rate of the overall fabrication process.

7. The acceptable defect positioning method for large-scaled photomask blanks of claim 2, wherein the non-critical area refers to area that does not reduce the passing rate of the overall fabrication process.

8. A method for manufacturing large-scaled photomask, comprising the steps of:
introducing an etched and to-be-repaired photomask to a photomask inspection system;
capturing an image of the photomask by the photomask inspection system;
comparing the image of the photomask by the photomask inspection system;
outputting positions of the defects on the photomask by the photomask inspection system;
determining the positions of the defects on the photomask that are within a critical area; and
repairing the defects on the photomask that are within the critical area by a photomask repair system.

9. The method for manufacturing large-scaled photomask of claim 8, wherein the step of determining the positions of the defects on the photomask is performed by the photomask inspection system.

10. The method for manufacturing large-scaled photomask of claim 8, wherein parts of the frames for capturing the image of the photomask by the photomask inspection system overlap each other.

11. The method for manufacturing large-scaled photomask of claim 9, wherein parts of the frames for capturing the image of the photomask by the photomask inspection system overlap each other.

12. The method for manufacturing large-scaled photomask of claim 8, wherein the critical area refers to area that will reduce the passing rate of the overall fabrication process.

13. The method for manufacturing large-scaled photomask of claim 9, wherein the critical area refers to area that will reduce the passing rate of the overall fabrication process.
